(19) United States
(12) Patent Application Publication
(10) Pub. No.: US 2020/0308359 A1
(43) Pub. Date: Oct. 1, 2020

(54) COMPOSITIONS AND PROCESSES FOR RENEWABLE RIGID FOAM

(71) Applicants: The United States of America, as represented by the Secretary of Agriculture, Washington, DC (US); World Centric, Rohnert Park, CA (US)

(72) Inventors: Gregory M. Glenn, American Canyon, CA (US); Xing Jin, Albany, CA (US); Gaunt Murdock, Crockett, CA (US)

(21) Appl. No.: 16/832,650

(22) Filed: Mar. 27, 2020

Related U.S. Application Data
(60) Provisional application No. 62/826,201, filed on Mar. 29, 2019.

(51) Int. Cl. C08J 9/00; C08J 9/28

(52) U.S. Cl. CPC C08J 9/009; C08J 9/0095; C08J 2403/02; C08J 2301/02; C08J 2429/04; C08J 9/28

(57) ABSTRACT

A composition comprising a fiber component, at least one surfactant/foaming agent, at least one dispersant, and optionally at least one binder, wherein the fiber component forms a viscous mixture that is converted to a foam product upon the addition of the surfactant/foaming agent once the viscous mixture reaches a predetermined dryness, wherein the foam product is resistant to shrinkage during drying and remains rigid.

### REFERENCE TO RELATED APPLICATION

This application claims the benefit of U.S. Provisional Application No. 62/826,201, filed 29 Mar. 2019, which is incorporated herein by reference in its entirety.

### FIELD OF THE INVENTION

The present invention relates to biodegradable foam compositions made from renewable sources and processes of making such compositions. More particularly the present invention relates to biodegradable rigid foam compositions and processes of making articles such as containers, packages, and sheets from such compositions.

### BACKGROUND OF THE INVENTION

Foam materials are important in many industrial sectors. Foaming not only confers useful mechanical and insulative properties to products but also minimizes costs by reducing the amount of material needed. Polyurethane foam (PUF), for example, has become nearly a $54 billion industry in the U.S. (see e.g., J. Moon, et al., Synthesis of polyurethane foam from ultrasonically decrosslinked automotive seat cushions, Waste Management, 85: 557-562 (2019)). Other common foam products are made from polyethylene (PE) and polystyrene (PS). Foam based on varieties of PUF, PE, and PS are generally used for building insulation and many other applications, such as cushions, shoes, and helmets (see e.g., L. Aditya, et al., A review on insulation materials for energy conservation in buildings, Renewable and Sustainable Energy Reviews, 73: 1352-1365 (2017); N. Mills, et al., Polymer foams for personal protection: cushions, shoes and helmets, Composites science and technology, 63(16): 2389-2400 (2003)). Extruded PS (XPS) and expanded PS (EPS) have also become widely used in disposable, single-use products such as coffee cups, trays, bowls, plates, cartons, and takeaway food containers, and packaging materials for temperature and impact protection (see e.g., N. Chaukura, et al., Potential uses and value-added products derived from waste polystyrene in developing countries: A review, Resources, Conservation and Recycling, 107: 157-165 (2016)). Although XPS and EPS foam is lightweight, inexpensive, and has excellent properties (e.g., high thermal, moisture, and impact resistance), it is not compostable or biodegradable, which is especially problematic when used for fast food and beverage containers that are often disposed of improperly and found accumulating in waterways, beaches, along roadsides, and many other areas. Thus there is a growing demand for food and beverage containers and protective packaging made of renewable, compostable materials. Several large cities have banned the use of polystyrene foam containers creating an additional impetus for such demand.

Containers and other packaging materials are generally designed to protect items from external damage (e.g., moisture, impacts, crushes, vibration, leakage, spills, gases, light, extreme temperatures, contamination, animal and insect intrusion, etc.) and may also contain information about the items therein. For example, materials ranging from protective packaging materials for shipping to plates and cups designed for use in the food and beverage industries are widely used throughout the world. The concept of single-use food and beverage containers in particular as an inexpensive, sanitary, and convenient alternative to reusable types has increased nearly fivefold since 1960. The value of single-use food and beverage containers in safeguarding human health and improving hygiene is often lost in the discussion of its role as a convenience and as a significant source of pollution and municipal solid waste. Plastics of various types (e.g., polystyrene, polyethylene terephthalate, polypropylene, high-density polyethylene, low-density polyethylene, polycarbonate, etc.) are commonly used and offer the benefit of ease of manufacturing, light weight, low cost, and inherent moisture and oil resistance. Polystyrene is a commonly and extensively used plastic for thermal and impact protection of shipped products and take-out food containers, and the like because of, for example, the ease of forming it into polystyrene foam. It is estimated that 0.83 MMT of polystyrene plates and cups were used in 2012 and discarded as municipal waste (see e.g., EPA, U., Municipal Solid Waste Generation, Recycling, and Disposal in the United States: Facts and Figures for 2012).

Reducing the environmental footprint of disposable packaging is a societal challenge because, for polystyrene foam in particular, very little is typically re-used or recycled. Interest in sustainable solutions has led to the development of products made from renewable materials including starch, poly(lactic acid) and poly(hydroxybutyrate), among others, which continue to be pursued as sustainable materials for various containers including for food and beverage use (see e.g., Farah, S., et al., Advanced drug delivery reviews, 107: 367-392 (2106); Widiastuti, I., et al, AIP Conference Proceedings, 2016; AIP Publishing: 2016; p 030020; Musiol, M., et al., European Food Research and Technology, 242: 815-823 (2016); Arrieta, M., et al., Multifunctional Polymeric Nanocomposites Based on Cellulosic Reinforcements, 205 (2016)).

Plant-based materials such as cellulose are desirable partly because they are renewable and have a lower cost. Cellulose is the most abundant polymer on earth as it is the major structural element of all plants. There are large areas devoted to growing crops such as corn, wheat, soybeans, and native grasses as well as forests where cellulose may be harvested. In addition to lumber for building, wood is processed via heating in an aqueous slurry containing chemical additives into fibrous pulp for making paper and cardboard. The pulping process removes part of the lignin and hemicellulose which binds cellulose fibers together in wood thus making it easier to disperse the fibers into a fine suspension. The price of pulp and paper varies considerably but is generally less than the price of commodity petroleum-based polymers making lignocellulosic materials economically attractive as replacements for petroleum-based plastics.

The use of such biodegradable and/or sustainable materials in consumer products continues to expand in various industrial sectors including packaging, construction, agriculture, and personal hygiene (see e.g., T. Huber, et al., A critical review of all-cellulose composites, Journal of Materials Science, 47(3): 1171-1186 (2012); K. G. Satyanarayana, et al., Biodegradable composites based on lignocellulosic fibers—An overview, Progress in polymer science, 34(9): 982-1021 (2019)). Plant fibers are considered an important and inexpensive replacement for petroleum-based and other nonrenewable products for certain applications (see e.g., M. J. John & S. Thomas, Biofibres and biocomposites, Carbohydrate polymers, 71(3): 343-364 (2008); N. Abilash & M. Sivapragash, Environmental benefits of eco-friendly natural fiber reinforced polymeric composite materials, International Journal of Application or Innovation in Engineering & Management, 2(1): 53-59 (2013)). Recent research has focused on improving the process for manufacturing wet fiber foam (see e.g., U.S. Pat. No. 6,500,302), fiber networks with large pore size for tissue production (see e.g., A. M. Al-Qararah, et al., Exceptional pore size distribution in foam-formed fibre networks, Nordic Pulp and Paper Research Journal, 27(2): 226 (2012)), very low density cellulose foam (see e.g., A. Madani, et al., Ultra-lightweight paper foams: processing and properties, Cellulose 21(3): 2023-2031 (2014)), and lightweight, rigid foam made with nano-fibrillated cellulose (see e.g., N. T. Cervin, et al., Lightweight and strong cellulose materials made from aqueous foams stabilized by nanofibrillated cellulose, Biomacromolecules, 14(2): 503-511 (2013)). The foam-forming technology facilitates the production of paper and paperboard with improved properties (see e.g., J. Poranen, et al., Breakthrough in papermaking resource efficiency with foam forming, 2013). There is also commercial interest in using fiber foam for thermal and sound insulation. Thermal insulation of cellulose loose-fill or cellulose batt is used in home insulation as an alternative to fiber glass batt insulation. However, conventional cellulose-based foams are not generally as rigid as, for example PS foams.

Most of the compostable foam technologies (e.g., cellulose fiber foam) have either cost or technology limitations, which causes continued widespread use of conventional plastic-based foams for packing and food service among other applications. There is an established manufacturing process for making foam mats. The process first involves suspending fiber in a dilute aqueous solution containing a surfactant (see e.g., O. Timofeev, et al., Drying of foam-formed mats from virgin pine fibers, Drying technology, 34(10): 1210-1218 (2016)). The mixture is converted into a foam by incorporating air via high-speed blending and the resultant foam is then formed into a mat sheet that is dewatered by drainage. The drainage may be facilitated by using vacuum, moderate compression, or other forces. Drainage and liquid flow are influenced by gravity and capillary forces within the fiber mat. The drainage equilibrium is reached when forces such as capillary pressure, gravity, mechanical pressure, and vacuum are balanced. At this point, the volume of liquid within the foam typically does not change and a drying phase is needed to further reduce the liquid content. Also, the foam structure may be lost if external mechanical pressure is applied. Although cellulose fiber foam is a sustainable material made of plant fiber, the conventional process begins with a foam having excessive water content and results in a final product which is subject to substantial shrinkage during processing.

Current methods used for making cellulose foam from a wet foam are effective in making very low-density foams (>0.02 g/cm³). However, the foam is not rigid, and the process does not fit well for making products that have desirable qualities for commercial use. For instance, the large volume of water used for making the foam requires a lengthy dewatering step and, in addition, the foam shrinks considerably during the dewatering step making the foam dimensionally unstable. A considerable amount of the foaming agent or any other additive is also lost during the dewatering step.

There thus exists an ongoing need for low-cost compostable rigid foam products to minimize the use of plastic products, and rely more on sustainable technologies. There exists a particular need for such products that are rigid, do not require lengthy drying times, and are easily dried with minimal shrinkage to provide increased environmental and economic advantages.

### SUMMARY OF THE INVENTION

This invention addresses the ongoing need by providing foam compositions comprising renewable fiber(s) and processes of making such compositions. The present invention resolves several factors that limited the success of known processes for making articles from conventional fiber-based formulations. All the equipment used to process the inventive compositions are commonly used commercially, for example in the food container or plastics industries. Many commercially available foams that are currently available generally require the use of expensive extrusion equipment. Although it can be adapted to work with extrusion equipment, the subject invention does not require expensive extrusion equipment or other custom equipment. In addition, if a specific shape is desired, the fiber foam of the invention can be made with binders that allow it to be compression-molded as a post-processing step. If desired, the inventive compositions may be dried outside of the mold and before it is compression molded into a shape. By drying the foam outside of the mold, it can be done more efficiently and under ambient conditions if desired so that energy costs are minimized.

In an aspect, the foam compositions of the invention comprise a fiber component, at least one optional binder (e.g., starch and/or polyvinyl alcohol, PVA) distributed essentially throughout the fiber component to create a fiber matrix comprised of individually separated fibers essentially devoid of masses of clumped fiber, at least one dispersant, and at least one surfactant/foaming agent. The surfactant can serve two functions: as a foaming agent and also as a dispersant to help disperse the fiber. Likewise, starch and PVA which act as binders can also function as fiber dispersants. In addition, some additives (e.g., PVA, sodium silicate) help facilitate the formation of foam bubbles during the mixing/shearing step. Some fibers and/or binders (e.g., starch) tend to suppress the foaming action of the surfactant/foaming agent. In such instances, a PVA solution aids in achieving a desirable amount of foaming. The fiber component, the surfactant/foaming agent, the dispersant, and optionally the binder combine to form a foam product that is resistant to shrinkage during drying and remains rigid. The surfactant/foaming agent is generally added to the inventive composition when the fiber component reaches a predetermined level of dryness. To provide additional resistance to shrinkage, polylactic acid (PLA) fiber (less than about 0.1 mm in thickness) or stiff fibers such as wheat straw or PLA fibers with a thickness in the range of about 0.25 mm to about 0.75 mm may also be used in the composition. The final foam product is a rigid foam that can provide thermal, acoustical, and impact insulation or it can be formulated with binders such as starch and compressed into finished articles such as plates or used as a moldable foam insulation. To provide additional resistance to shrinkage, PLA fiber may also be used in the composition. The final biodegradable foam product is a rigid foam that can provide thermal, acoustical, and impact insulation or it can be formulated with binders and compressed into finished articles such as plates or used as a moldable foam insulation.

It is an advantage of the invention to provide novel compositions and processes for rigid, compressible, and renewable foam composites comprised of fiber, at least one dispersant, at least one binder, optionally a filler, and a surfactant as a foaming agent.

It is another advantage of the present invention to provide foam composites that are scalable to commercial mass production using equipment that is common to the food and plastic industries to keep capital costs low while also being adaptable to extrusion equipment if desired.

It is a further advantage of the present invention to provide novel compostable foam food service products comparable to the convenience and cost of conventional paper products.

It is yet another advantage of the present invention to provide compositions that are compressible and moldable (or extrudable) into a variety of articles including packaging materials and food containers as well as thermal, acoustic, and impact insulation and may also be dried with little or no shrinkage.

An additional advantage of the invention is to provide novel compositions that are resistant to shrinkage and that may be dried with greater efficiency resulting in minimal water use during processing.

Yet another advantage of the invention is to provide cellulose foam compositions that are rigid and stable and require minimal water removal during or after processing.

A further advantage of the invention is to provide cellulose foam compositions that are rigid and stable without a requirement for active water removal during or after processing.

This summary is provided to introduce a selection of concepts in a simplified form that are further described below in the detailed description. This summary is not intended to identify all key or essential features of the claimed subject matter, nor is it intended to limit the scope of the claimed subject matter.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 shows a general scheme for the process of producing the compositions as described below.

FIG. 2 shows force-deformation curves for wet foam made from the F1 and F3 formulations as described below.

FIG. 3 shows stress/strain curves for the fiber foam of the invention and comparative polystyrene tested up to 10% compressive deformation as described below.

FIG. 4 is a photograph illustrating the textural differences between samples made from formulations F1, F2, and F3 (left to right) as described below.

FIG. 5 is a magnified photograph illustrating the fine network textural properties of a dry foam sample made from formulation 2 (F2) as described below.

FIG. 6 is a magnified photograph illustrating the coarse network textural properties of a dry foam sample made from formulation 3 (F3) as described below.

FIG. 7 is a photomicrograph of the fiber network from dry foam made from F3 showing the coarse fiber bundles as described below.

FIG. 8 is a photomicrograph of the fiber network from dry foam made from F2 showing the fine fiber bundles of PLA interspersed throughout as described below.

### DETAILED DESCRIPTION OF THE INVENTION

Unless herein defined otherwise, all technical and scientific terms used herein generally have the same meaning as commonly understood by one of ordinary skill in the art to which this invention belongs. The definitions herein described may or may not be used in capitalized as well as singular or plural form herein and are intended to be used as a guide for one of ordinary skill in the art to make and use the invention and are not intended to limit the scope of the claimed invention. Mention of trade names or commercial products herein is solely for the purpose of providing specific information or examples and does not imply recommendation or endorsement of such products.

As used in the description of the invention and the appended claims, the singular forms “a,” “an,” and “the” are intended to include the plural forms as well, unless the context clearly indicates otherwise.

The term “binder” refers to any water-soluble component added to the inventive composition that results in increased rigidity. For example, such components may be selected from polyvinyl alcohols, starches, sodium silicate, gelatin, gums, alginate, and the like, and combinations thereof. The binder may also include polymer solutions, melted waxes, and the like that can be infiltrated into a porous fiber matrix and then dried to remove solvent in the case of polymer solutions or cooled as in the case of melted waxes to confer additional rigidity and/or moisture resistance.

The term “biopolymer” refers to any polymer with repeating units derived at least partially or fully from a biologically renewable source (e.g., bio-based) including via agricultural production.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). This term may be substituted for inclusive terms such as “comprising” or “including” to more narrowly define any of the disclosed embodiments or combinations/sub-combinations thereof. Furthermore, the exclusive term “consisting” is also understood to be substitutable for these inclusive terms.

The terms “container” or “package” and like terms as used herein refers to any article, receptacle, or vessel used for storing, dispensing, transferring, packaging, protecting (e.g., impact, movement, and thermal protection), cushioning, portioning, or shipping various types of products, objects, or items (e.g., food and beverage products). Specific examples of such containers include boxes, cups, jars, bottles, plates, dishes, bowls, trays, cartons, cases, crates, cereal boxes, frozen food boxes, milk cartons, carriers and holders (e.g., egg cartons, 6-pack holders, boxes, bags, sacks), lids, straws, envelopes, and the like as well as packing material (e.g., loose-fill packaging peanuts, corner protectors, equipment bracing, insulative packaging, thermal shipping boxes/containers, foam coolers, and the like).

The term “effective amount” of a compound or property as provided herein is meant such amount as is capable of performing the function of the compound or property for which an effective amount is expressed. As is pointed out herein, the exact amount required will vary from process to process, depending on recognized variables such as the compounds employed and various internal and external conditions observed as would be interpreted by one of ordinary skill in the art. Thus, it is not possible to specify an exact “effective amount,” though preferred ranges have been provided herein. An appropriate effective amount may be determined, however, by one of ordinary skill in the art using only routine experimentation

The term “fiber” refers to a plant-derived complex carbohydrate generally forming threads or filaments, often categorized as either water soluble or water insoluble, which as a class of natural or synthetic materials, have an axis of symmetry determined by their length-to-diameter (L/D) ratio. They may vary in their shape such as filamentous, cylindrical, oval, round, elongated, globular, the like, and combinations thereof. Their size may range from nanometers up to millimeters. As an additive in a latex film, for example, fibers generally serve as a filler material that provides dimensional stability and changes in texture to the final product. Natural fibers are generally derived from substances such as cellulose, hemicellulose, lignin, pectin, and proteins.

The term “matrix” as used herein refers generally to a dispersion of fiber that is generally intercalated.

The term “optional” or “optionally” means that the subsequently described event or circumstance may or may not occur, and that the description includes instances in which said event or circumstance occurs and instances where it does not. For example, the phrase “optionally comprising a filler” means that the composition may or may not contain a filler and that this description includes compositions that contain and do not contain a filler. Also, by example, the phrase “optionally adding a filler” means that the method (or process) may or may not involve adding a filler and that this description includes methods (or processes) that involve and do not involve adding a filler.

The term “polylactic acid” or “PLA” means a biodegradable thermoplastic aliphatic polyester often derived commercially from bio-based precursors such as corn starch, tapioca starch, sugarcane, wheat straw, the like, and combinations thereof. This polymer can include both L-lactyl monomeric units (i.e., primarily comprised of lactic acid L-enantiomer, which is the opposite enantiomer (e.g., mirror image) of the D-enantiomer) and/or D-lactyl monomeric units (i.e., primarily comprised of lactic acid D-enantiomer, which is the opposite enantiomer (e.g., mirror image) of the L-enantiomer).

The term “rigid” refers to a porous fiber matrix that resists compressive deformation. That is, significant plastic deformation occurs with excessive compression force. Excessive deformation tends to disrupt the original structure and strength. Once the original structure is disrupted, the foam typically will not rebound to the original structure and dimensions with foams. The rigid foams generally have a modulus in MPa of about 0.1 to about 1.5 MPa.

The term “foaming agent” refers to a chemical which facilities the process of forming a wet foam and enables it with the ability to support its integrity by giving strength to each single bubble of foam. The concrete industry utilizes foaming agents for making cellular concrete. Such foaming agents may also be used for making cellulose foams. These foaming agents include hydrolyzed protein formulations as well as synthetic formulations that are proprietary. Other well-known surfactants that can be used as foaming agents may include alkyl sulfates such as sodium dodecyl sulfate (SDS), alkyl ether sulfates such as sodium lauryl ether sulfate (SLES), and other anionic and cationic surfactants.

The term “dispersant” as used in this case refers to any compound that when used in an aqueous environment facilitates the separation of fibers which normally tend to agglomerate into clumps or masses. The clumping or agglomerating of fibers produces a heterogenous mixture and results in a weaker foam structure. Properly separating fibers using dispersants in an aqueous environment produces better intermeshing and overlapping of individual fibers and produces a strong fiber foam structure.

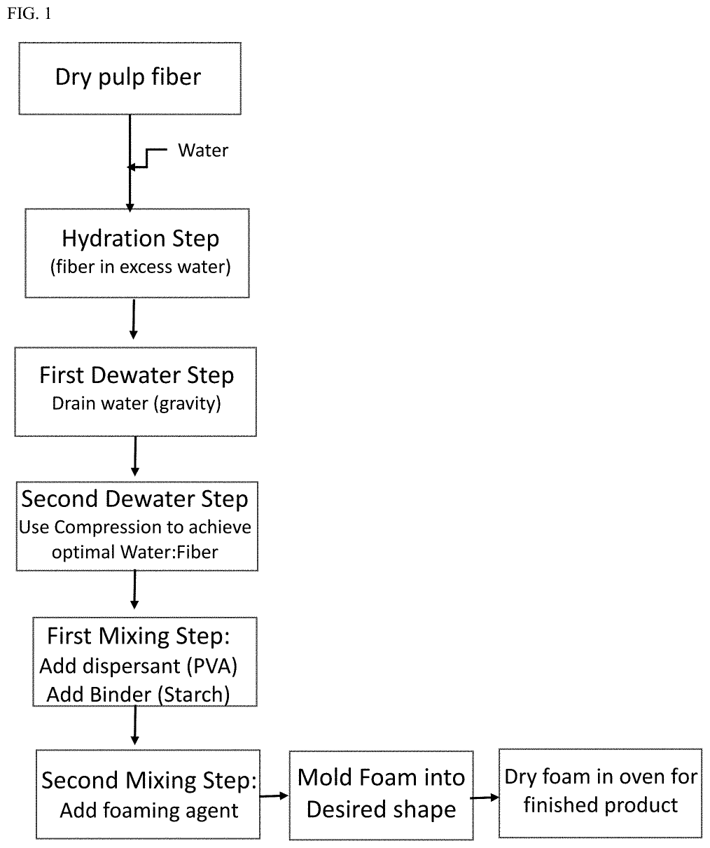

FIG. 1 shows an example of a general scheme on how to make the compositions which contain fiber, at least one dispersant, at least one binder, and at least one surfactant/foaming agent. Dry pulp fiber is mixed in water (e.g., about 1° C.-about 100° C., preferably about 15° C.-about 90° C., more preferably about 60° C.-about 80° C.) to hydrate the fiber. Excess water is then removed; for example, in a first dewatering step followed by a second dewatering step. Then the fiber is mixed with a dispersant (e.g., PVA) and a binder (e.g., starch). Then a foaming agent (e.g., SDS) is mixed in with the fiber, dispersant and binder. Alternatively, the foaming agent can be added with the dispersant and binder in 1 mixing step although it is preferred to have the binder mixed in and dissolved before adding the foaming agent. The resulting foam can be molded into the desired shape and dried (e.g., in an oven). PVA can also help with foaming and as a binder, starch can also help disperse fiber, and the foaming agent can also act as a surfactant and dispersant. For example, PVA may be utilized as the both the dispersant and the binder. Alternatively, starch may be utilized as both the dispersant and the binder. One advantage of our process is that we eliminate the dewatering steps of the prior art. We are dewatering but we are doing it before adding our dispersant, binder, and foaming agent. In the prior art, they added the foaming agent before dewatering so they lose all their additives contained in the water that was discarded. We hydrate the fiber first with only water and we dewater before adding any additives. We get the moisture content to our desired, low levels before adding additives. Thus in our process, we do not waste any additives by discarding during the dewatering step.

The cellulose foams of the invention are generally made with various degrees of rigidity by using fiber hydration, dewatering, and mixing steps. Surprisingly, the dewatered fiber used in the invention which appears much too dry to create a foam still can make a foam with the addition of foaming agent, a small amount of water or binder, and rigorous mixing. One skilled in art would view the dewatered fiber as having an appearance that is much too dry to be able to foam in the presence of a foaming agent. Having such a minimum amount of water in the fiber mixture yet still producing a foam upon the addition of a foaming agent was surprising and unexpected. Furthermore, the bubbles created with the low moisture foam are smaller and result in a dry foam that not only has low density, but also has high compressive strength (as detailed below). The wet foam is stable and can be transferred into a mold and dried in situ or it can be spread into sheets, for example. Due to the low moisture content of the foam relative to prior methods, the dewatering step (normally required in the prior art) is minimized or eliminated and there is virtually no loss of foaming agent or binders and drying times are reduced. Prior methods for foaming typically added the foaming agent to a very dilute fiber suspension. This dilute mixture was easy to foam but it was so wet that it needed to be drained or dewatered to a much larger extent than the inventive composition, which made it impractical to add binders or fillers because those would generally be lost in the dewatering step. By hydrating and dewatering the fiber in using the inventive processes, the fibers remain easily dispersible. The inventive processes reduce or eliminate any loss of foaming agent or binders or fillers because there is no subsequent dewatering step that would throw out the water and the ingredients that were added into the mixture. There is also minimal shrinkage observed during the drying step, which can be done under ambient conditions or with the use of an oven. The biodegradable cellulose foam has low density, excellent insulation properties, and can have excellent compressive strength depending on the binders used. Furthermore, the dry foam can be compression molded into articles.

The present invention provides novel compositions comprising a fiber component, at least one foaming agent, at least one dispersant, and optionally at least one binder. In preferred embodiments, the optional binder is distributed essentially throughout the fiber component to create a matrix, and the fiber component, dispersant, and the foaming agent combine to form a foam product that is dimensionally stable and resistant to shrinkage during drying. Dimensional stability in this context refers to the lack of shrinkage during the drying step. Excess shrinkage can cause a sheet of foam to be significantly thinner in the middle than the edges where there is generally more support. Excess shrinkage can also cause a foam to partially collapse and densify such that the final density and volume is unpredictable. Dimensional stability allows, for example, a 1-inch thick sheet of foam to dry and essentially still be uniformly 1 inch in thickness. If the foam is scooped into an empty cavity, it is desirable that the final volume of the dry foam be similar to the wet foam. If excessive shrinkage occurs during drying, an additional quantity of foam may need to be added to ensure the filled cavity is still full once the foam dries. Generally, one or more types of fiber are dispersed throughout a matrix forming a foam when combined with a foaming agent. Processes of making such compositions generally for use to form containers and other articles are also herein described.

In embodiments, the fiber component is a fiber selected from any number of plant-derived complex carbohydrates such as, for example, wood, straw, rice hull, almond hull, or other waste products. Generally, the fiber component acts to reinforce the inventive composition and provide mechanical integrity and additional benefits as herein described. In embodiments, a fiber component such as fibers from crop waste can be partially or wholly substituted in the formulation of the invention to create a more sustainable product having a lower environmental footprint than conventional fiber-based products. Lignocellulosic fibers separated and prepared by chemically and/or mechanically separating such fibers from, for example, wood (e.g., hardwood or softwood or combinations), fiber crops (e.g., sisal, hemp, linen, and the like, and combinations thereof, etc.), crop waste fibers (e.g., wheat straw, onion, artichoke, other underutilized fiber sources, and the like, and combinations thereof, etc.), and waste paper to make pulped fibers where soluble material has been removed from the fiber are preferred. However, it should be appreciated that any type of fiber known in the art may be utilized for use in the invention. The fiber component is present in the composition in an amount ranging from about 82 wt % to about 95 wt %, or from about 92 wt % to about 89 wt %, or from about 89 wt % to about 95 wt % fiber as measured in the dry foam (typically for foams of the invention containing only a fiber component and a surfactant without binder will have a higher amount of fiber present in the final formulation). Formulations containing PVA, for example, as a binder may have a lower amount of fiber present in the final formulation such as from about 82 wt % to about 89 wt % fiber in the dry foam. When fillers are present in the foam compositions, lower amounts of fiber may be present such as from about 40 wt % to about 80 wt %. Prior to drying (e.g., see formulations in Table 1) there is generally from about 40 wt % to about 70 wt % fiber depending on the particular formulation.

Preferred fibers are natural fibers that provide properties to achieve an essentially homogenous dispersion in the final product, more preferred are pulped plant fibers greater than about 0.5 mm (e.g., 0.5 mm) in length, and most preferred are pulped plant fibers with fiber lengths greater than about 2 mm (e.g., 2 mm) in length up to about 5 mm (e.g., 5 mm) or about 8 mm (e.g., 8 mm) or about 10 mm (e.g., 10 mm) in length. It should be appreciated that there is not necessarily a limit for minimum fiber length, but smaller fibers typically confer less strength to the final product. There is, however, a limit to the maximum fiber length. Fibers that are too long tend to mix poorly and it is very difficult to get a homogenous mixture of the ingredients. Not intending to be theory-bound, the upper limit for fiber length is thought to be about 10 mm. Fibers having a length less than about 0.5 mm may also be used but generally will act as a filler rather than contributing to the strength of the final foam product. One skilled in the art may observe that the optimal amount of water will vary with the particular fiber source. The operator will need to develop an optimal level of water for every fiber mixture of interest. Some plant fibers absorb more water than others during the hydration step and that will affect the amount of water added to achieve an optimal level of hydration. In all cases, the amount of water added should be reduced until a foam cannot be attained. Once that point is defined for a given fiber mixture, the water should be increased to achieve the optimal mixture.

The binder acts as an agent to hold together or “cement” the individual fibers together in the dry foam. The binding agent remains essentially evenly distributed throughout the matrix and also aids in ensuring the fiber component remains evenly distributed throughout the matrix and provides increased rigidity for the final product. In embodiments, the binder may be derived from a variety of agricultural sources and commodities or synthetic materials and is generally comprised of components such as PVA, starches, sodium silicate, gelatin, gums, alginate, and the like, and combinations thereof. For example, binding agents derived from natural sources and starches including proteins from corn, wheat, soy; starches from commercial crops including corn, wheat, potato, cassava, pea, etc.; waxes from plant sources such as soy or from petroleum-derived chemicals; and polymer solutions including PVA dissolved in water, PLA dissolved in solvent, shellac dissolved in ethyl alcohol, etc., may be used as the binder. The degree that the binders affect rigidity depends on the concentration used and the mobility of the binder in water. For instance, a small molecular weight binder like sodium silicate easily travels with the moisture flow during drying. Hence, most of the binder may migrate to the outer surfaces of the foam during drying. In contrast, high molecular weight binders such as starch are much less mobile during the drying process and are more prone to binding the fiber throughout the foam structure. The binders can also improve the flexural strength of the foam. Such foam samples do not pull apart as easily as foams with no binder. Some of the binders such as shellac, waxes, and PLA not only increase rigidity and flexural strength but also improve moisture resistance. In the inventive composition, the binder is distributed essentially throughout the matrix and contributes to the desired level of high compressive strength of the wet foam (higher compressive strength of the wet foam means less shrinkage of the foam during the drying step, see examples). Starch is generally comprised of amylose and amylopectins that are high molecular weight and soluble in water. When granular starch is heated in water, the granules swell and absorb water. The high molecular weight starch polymers disperse and increase viscosity in water. Adding more starch tends to increase the concentration of the starch polymers solubilized in the water thus further increasing viscosity. It is also well known in the literature that starch is easily biodegradable compared to fiber so having higher levels in the inventive composition results in a more environmentally conscious product.

In embodiments, the binder is preferably present in the inventive composition in an amount ranging from about 1 wt % (e.g., 1 wt %) to about 50 wt % (e.g., 50 wt %), or from about 2 wt % (e.g., 2 wt %) to about 30 wt % (e.g., 30 wt %), or from about 3 wt % (e.g., 3 wt %) to about 10 wt % (e.g., 10 wt %). It should be appreciated that the amount of a solution of a particular binder that is added may vary depending on the concentration to arrive at the desired amount in the final formulation.

In embodiments, the inventive composition includes a foaming agent. Preferably the foaming agent is selected from anionic and cationic surfactants known in the art. Such surfactants might be developed for other industrial purposes but have foaming capability needed for the present invention. Non-ionic surfactants do not tend to foam as well so they are not recommended. Other foaming agents such as those commonly used for concrete made from hydrolyzed protein as well as proteins like egg albumin are also able to produce foam. Preferred foaming agents include sodium dodecyl sulfate and commercial foaming agents (e.g., CMX Foam Concentrate, Richway Industries, LTD., Janesville, Iowa). Though it is known that various dilute solutions create foams with the addition of a surfactant, it was a surprising and unexpected result that the viscous fiber composition of the invention could be readily foamed with the addition of a foaming agent. The action of bubbles forming within the fiber matrix effectively separates individual fibers producing a homogenous fiber foam that can flow without the fiber component separating out or clumping together. Even a small amount of foaming can be sufficient to help the fiber composition to flow when external pressure is applied. Achieving a wet fiber foam consisting of a matrix of bubbles in which the fiber component is well dispersed or suspended is desirable. The foaming agent is added to the fiber suspension when the water:fiber ratio is from about 2:1 to about 8:1, or from about 2:1 to about 5:1, or from about 2:1 to about 3:1. In the final formulation, the foaming agent is present in amounts ranging from about 1 wt % to about 10 wt %, or from about 3 wt % to about 8 wt %, or from about 5 wt % to about 7 wt %.

In embodiments, the inventive composition includes at least one dispersant which may act in conjunction with the foaming agent. The dispersant may provide a mechanism for the fiber component to distribute throughout the matrix (e.g., matrix of bubbles) and create a viscous dough in combination with the other components of the disclosed composition to cause a foam to form and help prevent the tendency of pulped fibers to agglomerate and form clumps. Addition of a dispersant and/or foaming agent to the inventive composition (with or without optional physical shear) effectively separates the fibers into single fibers that are uniformly distributed throughout the foam matrix. Properly dispersed fibers strengthen and reinforce the matrix. Fiber clumps are not desirable and do not provide desired strength or reinforcement to the inventive composition or products formed therefrom. The ability of the dispersant to sufficiently distribute the fiber component throughout the matrix is dependent on using relatively small quantities of water as further discussed herein to create a dough with sufficiently high viscosity for use in the processes of the invention. Viscosity is measured by means known the art. For example, a texturometer may be used to measure characteristics of the force response (i.e., a way of profiling the viscosity) resulting from the mechanical properties (e.g., resistance, texture analysis, texture profile analysis, etc.) of the dough composition. Such mechanical properties correlate to specific sensory texture attributes and impacts the performance of the composition in forming articles as well as the quality and performance of those articles in various applications.

For example, the preferred force response as measured, for example, by inserting a 3.682 inch probe to a depth of about 20 mm in a container of the foam composition is from about 0.005 kN (about 510 grams) to about 0.02 kN (about 2,040 grams). It should be appreciated that the upper limit for the viscosity range is dependent on the compressive force of the molding equipment and also that the desired viscosity range may be adjusted by a skilled artisan for a particular application of the inventive composition. Stiffer dough typically holds its shape better when the molded part is demolded (i.e., removed from the mold). A more preferred resistance is greater than about 510 grams (e.g., 510 grams) and up to about 2,500 grams (e.g., 2,500 grams). The most preferred resistance is greater than about 600 grams (e.g., 600 grams or greater), or greater than about 2,500 grams (e.g., 2,500 grams), or greater than about 5,000 grams (e.g., 5,000 grams or greater), or greater than about 8,000 grams (e.g., 8,000 grams or greater) up to a maximum of 10,000 grams.

Examples of preferred fiber dispersants include PVA, gelatinized and pregelatinized starches, carboxymethyl cellulose and its derivatives, hydroxymethyl cellulose and its derivatives, water soluble viscosity modifiers including plant gums (e.g., plant gums like alginate, gums of guar, arabic, ghatti, tragacanth, karaya, xanthan, gellan, tara, glucomannan, locust bean, glucomannan, etc.). Preferred dispersing agents include those that provide an optimal balance of price and function and are naturally-derived. PVA, for example, is synthetic and rather expensive but provides strength and good oil resistance. Most preferred are starches because they are natural, cost effective, and biodegradable. In embodiments, the dispersant is present in the inventive composition in an amount ranging from about 0.5 wt % (e.g., 0.5 wt %) to about 10 wt % (e.g., 10 wt %), or from about 0.5 wt % (e.g., 0.5 wt %) to about 5 wt % (e.g., 5 wt %), or from about 0.5 wt % (e.g., 0.5 wt %) to about 5 wt % (e.g., 5 wt %).

The inventive composition may be formed by various processes. An example process includes dispersing fiber pulp in water (e.g., hot water) followed by catching the fiber on a screen to remove excess water. Optionally a binder may be added such as a gelatinized slurry of starch or pregelatinized starch powder or other binder as discussed herein. An optional filler such as calcium carbonate, and a fiber dispersant such as a dilute solution of PVA, may be added then thoroughly incorporated. The mixture generally has sufficient viscosity at this stage to facilitate the uniform dispersion of the fiber component throughout the matrix of the composition. After thorough mixing, a foaming agent is added (unless a foaming agent was used as the dispersant in which case additional foaming agent may not be necessary) to initiate the foaming process for the inventive composition. Alternatively, the foaming agent can be pre-foamed and added to the fiber mixture. An additional amount of water may be added if necessary to facilitate the foaming process. The mixture is rigorously stirred with a paddle mixer or other similar type mixer to effectively mix air into the composition. The foaming agent aids in forming a stable foam structure during the mixing process. The foam composition can then be poured or scooped into a mold or spread into a foam sheet. The foam material may be placed into an oven or air dried to remove at least a portion of the water in the mixture. The desired level of dryness is less than about 10 wt % water, or less than about 8 wt % water, or less than about 5 wt % water. Conventional wet foams have an undesirable tendency to collapse during the drying process. Surprisingly, the subject foam of the invention is sufficiently stable that it may be dried in an oven while still maintaining a desirable rigid and porous structure. There may also be some densification of the outer surface which leads to formation of a smooth, skin-like structure for the invention composition. However, much of the original foam structure is preserved in the drying process. The dry foam has considerable compressive strength and low density. There is typically a positive correlation between density and strength. The greater the density, the greater the compressive strength. For example, densities can range from about 0.02 g/cm³ to about 0.4 g/cm³. The denser samples have less pore space, are typically stronger, and have a binder. Compressive strength for about a 20% deformation range may be, for example, from about 1 kPA to more than about 80 kPa. Foam densities comparable to polystyrene foam (e.g., 0.05 g/cm³) may be obtained. The density of the inventive foam composition may be adjusted via the particular selected components and ranges from about 0.02 g/cm³ to about 0.10 g/cm³ or to about 0.4 g/cm³. For some applications, very low density and good thermal insulation properties may be desired. For other applications, higher density and good compressive strength may be desired. For thermal and acoustical insulation, for example, desirable densities are from about 0.02 g/cm³ to about 0.06 g/cm³. Examples of the relationship among density (g/cm³), rigidity (Modulus in MPa), and 20% compression strength (kN) are 0.062 g/cm³, 0.063 MPa, 10.50 kN; 0.043 g/cm³, 0.015 MPa, 2.47 kN; 0.039 g/cm³, 0.011 MPa, 2.12 kN; 0.080 g/cm³, 0.195 MPa, 35.10 kN; 0.052 g/cm³, 0.029 MPa, 6.02 kN; 0.054 g/cm³, 0.057 MPa, 11.9 kN. Cellulose fiber is hollow and is a very good insulator for both sound and heat. Thermal and acoustical insulation is enhanced by having a low-density foam consisting of well dispersed fibers and a small pore size. It creates dead space that restricts the transmission of heat and sound by convection. The lower the density and the smaller the cell size, the lower the transmission of heat by conduction. These two combined effects and the hollow nature of cellulose fibers produce excellent insulation properties.

Traditionally, a foaming agent is added to a very dilute mixture of fiber for making fiber foam. Typically, about 1% to about 5% fiber is mixed with a foaming agent. Because the resulting foam is so dilute, it needs to be dewatered significantly. The excess water drains very quickly at first but then drains very slowly. During drainage of such large volumes of water, the fiber volume continuously shrinks down as the water drains. Eventually, the water stops draining and the fiber must be dried in an oven. With this process, most of the soluble components such as the foaming agent is simply drained and discarded with the excess water unless specific efforts are made to reuse/recycle the foaming agent. This system is also impractical for adding water soluble binders because they also drain out with the excess water and are discarded unless specific efforts are made to reuse/recycle such components. The inventive concept, for example, is to pre-hydrate the fiber in excess water. The fiber and heated water are placed in a large blender and blended to separate the fibers and allow them to fully hydrate. Once the fiber is hydrated, the mixture may be blended again to ensure the fibers are well separated. Next, water is drained out on a screen and the fiber is squeezed out to remove even more water until a desired fiber:water ratio is achieved (e.g., about 1 to about 2). It should be appreciated that if, for example, 25 g of dry pulp fiber was simply mixed with 50 g water, the fiber would not be fully hydrated and dispersed. The pulp fiber comes in dry sheets that appear like thick paperboard. When they are dried in that manner, there is a considerable amount of hydrogen bonding between fibers. The hydration step loosens the fibers and breaks the hydrogen bonding. If the fiber was allowed to fully dry, hydrogen bonding would take place again and would not produce a desirable result. By pre-hydrating the fiber, the fibers are loosened and easily separated again. The dewatered or squeezed fiber mass is a solid mass with no free water. One skilled in art would predict that after adding the foaming agent, a considerable amount of liquid would be needed to allow the fiber mixture to foam. Surprisingly, mixing the fiber/foaming agent mixture resulted in the formation of very small bubbles. After continual rapid mixing, the foaming action progressed to where the volume of the mixture had increased due to more bubble formation. The advantage of minimizing the added water is that a foam is produced that shrinks very little when dried. Furthermore, any binders or fillers added to the mixture remains within the dried foam. In other words, the binders are less likely to migrate with water during the drying step due to the low initial water content. This is not possible when a foam is made with excess water and a dewatering step is required as is conventionally done in the art. The traditional method is to add all the ingredients in the excess water and then dewater afterwards which results in the wasting of the other ingredients that had been added to the water. When making foam from just fiber and foaming agent, the fiber:water ratios were as low as from about 1: about 2 to about 1: about 3. However, when adding a binder, more water may be necessary since the binder may absorb some of the water or reduce the foaming action. This all must be optimized for every composition by a skilled artisan.

The specific level of dryness will vary depending upon the formulation. It is important, therefore, to determine the optimum level of dryness for each composition. For formulations containing only the fiber component, water, dispersant, and foaming agent, the fiber is first hydrated in a blender with water heated to a relatively high temperature (e.g., to over about 60° C. but not to exceed the temperature of boiling water (100° C.). After blending for 1 minute, the fiber is allowed to hydrate for about 15-20 minutes before blending again for about 1 min and then catching the fiber on a sieve (e.g., 40 mesh). The fiber is gathered and compressed to squeeze out excess water. It is advantageous to minimize the water:fiber ratio to keep the drying time and drying energy as low as possible. It is more preferable to keep the water:fiber ratio less than about 5.0. It is even more preferable to keep the water:fiber ratio less than about 4.0. It is most preferable to keep the water:fiber ratio less than about 3.0 before adding the foaming agent. When adding binders such as starch or other fibers to the composition, the most preferable water:components ratio must be determined through trial and error. By minimizing the water content to the point where a foaming action occurs, the amount of shrinkage during drying is minimized, the rigidity of the foam is improved, and the drying time is minimized.

In embodiments, articles may be formed using the inventive composition in an economical and commercially efficient manner by allowing production of articles with short cycle times as compared to conventional compositions and methods. In conventional methods, for example, drying a molded article in a mold for long periods (e.g., about 60 to about 200 seconds) places burdensome limits on the production rate and increases costs. For example, when a binder such as starch is used in the inventive composition, it is compressed into a dry foam outside of the mold (typically having about 8% moisture at that point) and the dried foam is then compression molded in about 5 seconds. In addition, the present invention may employ existing production equipment (e.g., thermoforming machinery, hydraulic presses) which enhances its cost-effectiveness and commercial desirability and may also employ customized equipment to produce specialty items.

Final products (e.g., plates for food use, packaging materials, thermal insulation, acoustic insulation, etc.) formed from the inventive composition are generally similar in appearance to corresponding conventional products. Some potential applications could be as a replacement of polystyrene rigid packing foam for packaging equipment. Loose-fill packaging could be made by cutting the blocks of foam into a size similar to packaging peanuts. Since the foam is compressible, it can also be compression molded to form foam parts or it can be compressed into solid parts like food plates or bowls. For plates, the foam may be deposited on a sheet of film of a degradable polymer such as, for example PLA, biodegradable polyesters, or natural biopolymers like polyhydroxyalkanoates (PHAs). For example, once the foam has dried in the oven on the sheet of film, the foam can be pressed into a plate with the film-side on top. The film then confers the moisture and oil resistance needed in a functional plate for commercial use. Sheets of the material could also be compressed into a nonwoven sheet for use as filters. The material could be easily infiltrated with wax or polymer solutions to confer moisture resistance or other properties if a film coating is not desired. There are many other potential applications for compostable materials of the invention as envisioned by a skilled artisan.

Fiber composites may also be made using the inventive composition by compounding biopolymers including starch and poly(lactic acid) (PLA) with agricultural fibers as further described herein. The fiber source preferably includes rice hulls, straw, and almond hulls, among others. The fiber composites may be extruded through, for example, a twin screw extruder using rod dies of various diameters (e.g., about 2 mm to about 20 mm diameter depending on the size of the extrusion equipment—the larger the die, the less likely the fibers will agglomerate and plug the die). The exudates are pelletized and later processed into products (e.g., the pellets can be injection molded into a multitude of articles or extruded into sheets and thermoformed into a multitude of articles just as with conventional plastics) using, for example, a 50 ton injection molding machine. The strength and mechanical properties of the items will be comparable to or exceed commercially available cutlery made of neat PLA and other materials. Such fiber-reinforced composite materials of the invention may be directly used in producing commercial products.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurement. The following examples are intended only to further illustrate the invention and are not intended in any way to limit the scope of the invention as defined by the claims.

### Example 1

This example provides an illustration of producing the inventive composition using a variety of starting materials. Unbleached Kraft pulp was acquired from Port Townsend Paper Corp. (Port Townsend, Wash.). Fibers of poly(lactic acid) (PLA) were obtained from Minifibers, Inc. (Johnson City, Tenn.) with a fiber length of 6 mm and fiber diameter of 13 μm (1.5 denier). Pregelatinized, cold water-soluble potato starch (Emjel E70) was purchased from Emsland-Starke GmbH (Emlichheim, Germany) and used as a binder/dispersant. Calcium carbonate was purchased from Diamond K Gypsum (Richfield, Utah) and used as a low-cost filler. A commercially available foaming agent (Foamcell A100) was purchased from Goodson and Associates (Wheat Ridge, Colo.); alternatively, Richway CreteFoam™ CMX foam concentrate can be used. Poly(vinyl alcohol) (PVA, Celvol™ PVA 504) was purchased from Celanese Chemicals (Dallas, Tex.) and used as a dispersant/binder. Polystyrene foam sheet insulation (Insulfoam) is a common item and was purchased at a local hardware store.

Samples of the inventive composition were prepared for testing by first placing 40 grams of cellulose fiber in hot water (about 80° C.) in a Waring blender, and mixing for about 1 minute. The mixture was allowed to rest for about 15 min to allow the fiber fraction to fully hydrate. After resting for about 15 min, the mixture was again blended for about 30 seconds to ensure the fibers was thoroughly dispersed in the water. Excess water was removed (e.g., the contents of the blender were then poured onto a screen (120 mesh) to drain the excess water and the fiber was carefully gathered into a mass on the screen and manually compressed to remove additional water). The final weight of the hydrated fiber mass was 300 g (40 g fiber and 260 g water). The hydrated fiber mass was placed in a Hobart planetary-type mixer (Model N50) and stirred at the lowest speed (approximately 60 rpm). One hundred grams of 5% (w/w) PVA, or 5 grams of solid PVA could also be used, were added to the hydrated fiber mass which was then mixed for about 2 min. The PVA solution serves as a fiber dispersant even though it can have multiple affects (see e.g., H. Sievänen, Suitability of foam coating on application of thin liquid films, (2010)). Pregelatinized potato starch powder (15 g) was added as a binder to the sample during the mixing process. Since the starch tends to form lumps if added all at once, it is generally necessary to sprinkle the powder slowly into the mixture to avoid this problem. In addition to acting as a binder, the starch helps disperse the fiber by adhering to and pulling apart the fibers as the paddle kneads the viscous dough. Once all the starch was added, the mixture was thoroughly mixed for several minutes only stopping periodically to scrape down the mixing bowl.

Four grams of foaming agent (Foamcell A100) were next added to the mixing bowl. The contents of the mixing bowl were rigorously mixed for approximately 15 min. During this mixing stage, air was entrained via the mixing action into the viscous dough components. Initially, it appeared that more water or foaming agent would be necessary to create the desired foam product. However, once the foaming agent was uniformly dispersed throughout the sample, a foam was surprisingly created despite the thick, viscous nature of the mixture. The sample volume expanded approximately 8 to 12 times the original volume upon foaming. The mixing was stopped and the foam was scooped onto an aluminum plate lined with paper. Two spacers were placed on the edges of the plate and the foam was spread even with the spacers using a flat rod. A sheet of foam with uniform thickness (approximately 1 in×8 in×12 in) was formed and then placed inside a forced-air oven held at 80° C. The foam was dried overnight before removing from the oven.

### Example 2

This example illustrates the physical and mechanical characteristics of the inventive composition in both hydrated and non-hydrated form. Hydrated foam samples were prepared as described in Example 1 and scooped into the testing apparatus. The compressive strength and modulus of the samples were determined by pressing a 93 mm piston into a 100 mm cylinder of wet foam approximately to a 4 in depth. The force required to press the piston at a rate of 2.54 mm/min to a depth of 40 mm was recorded.

The dry (i.e., non-hydrated) foam samples were prepared by first filling a cylindrical mold (165 mm×80 mm) with hydrated foam prepared as previously described in Example 1. The foam cylinders were then dried overnight at 80° C. Foam density was determined by weight and volume measurements. Shrinkage during drying was recorded as previously described (O. Timofeev, et al., Drying of foam-formed mats from virgin pine fibers, Drying technology, 34(10): 1210-1218 (2016)). For mechanical tests, the dry foam samples were removed from the molds and preconditioned for 48 hours in an incubator at 54% relative humidity using a saturated salt solution of Ca(NO₃)₂ (L. B. Rockland, Saturated salt solutions for static control of relative humidity between 5° and 40° C., Analytical Chemistry, 32(10): 1375-1376 (1960)). Preconditioning to a standard level of relative humidity was performed because mechanical properties of the samples may change with moisture levels of the foam. The foam samples were compression tested as per ASTM D1621 using 10% deformation and a deformation rate of 2.54 mm/min. All mechanical tests were performed using a universal testing machine (Instron, Model 4500, Canton, Mass.).

Three different formulations were made into the inventive compositions as shown in Table 1. Three samples were made of each formulation for subsequent testing.

TABLE 1

| | Un- | PLA | Water + | 5% | Pre- | | |
|---|---|---|---|---|---|---|---|
| Sample | bleached | Fiber | Fiber | PVA | Gel | CaCO₃ | FoamCell |
| ID | Fiber (g) | (g) | (g) | (g) | (g) | (g) | (g) |
| F1 | 40 | 10 | 300 | 100 | 15 | 0 | 4 |
| F2 | 40 | 10 | 300 | 100 | 15 | 40 | 4 |
| F3 | 50 | 0 | 300 | 100 | 15 | 0 | 4 |

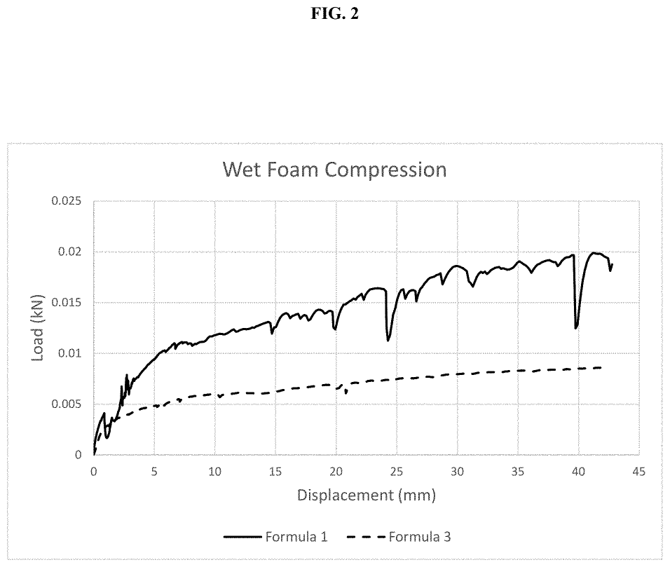

The wet foam-containing PLA fibers (F1) was stiffer than wet foam made only of unbleached cellulose fiber (F3). Force deformation curves show the PLA containing foam (F1) had approximately twice the compressive strength as the F3 sample made only of cellulose fiber (FIG. 2). Not intending to be theory-bound, the result that the dry F1 foam also had a higher compressive strength than the dry F3 foam sample may show a correlation between the compressive strength of wet foam and the compressive strength of the corresponding foam after it has dried. The wet foam stiffness is important in forming dimensionally stable foam materials that will dry without shrinking. Though all of the samples had little to no shrinkage, foam samples made of F3 were particularly robust and surprisingly demonstrated little or no shrinkage during the drying process (data not included). Wet foam samples using conventional methods of dispersing fiber in an excess of water and mixing it with SDS can be dewatered in a mold. The samples may generally shrink in excess of 100% of the original volume. The shrinkage from the tested foam samples was negligible even though the final density was relatively low. It is not as low in density as some of the conventionally prepared foams but was surprisingly very low density, had negligible shrinkage, and surprising rigidity compared to conventionally made foams.

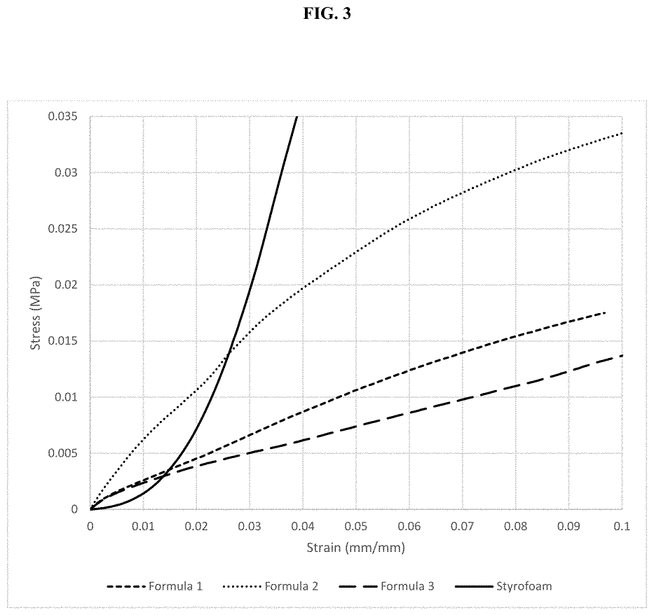

The results of the mechanical and physical tests of the dry foam show that the foam could be an effective replacement for polystyrene foam because the foams of the invention have similar properties. It was surprising and unexpected that the tested inventive samples had similar thermal insulative properties to polystyrene because the samples were higher in density than polystyrene. Thermal conductivity is known to typically increase with density, so it was surprising that the inventive foams which were denser had similar thermal conductivity values. Table 2 shows some of the physical and mechanical properties of the fiber foam samples compared to polystyrene foam. The samples were tested in compression up to 10% deformation. The R value for cellulose batt made by a traditional foaming method was 4.09 for comparison. Density of foam samples without CaCO₃ was approximately 0.036 g/cm³. The polystyrene sample tested had less than half the density of the inventive composition. However, the thermal insulation properties of the fiber foam were only slightly lower based on the measured R value. The compression stress/strain curves for the samples tested to 10% deformation show that the polystyrene sample had a larger modulus and peak strength than the fiber foam samples (FIG. 3). This finding suggests that the test results for the inventive foam composition surprisingly had comparable thermal insulative properties, but lower strength and rigidity as compared to polystyrene. It was observed that the purchased polystyrene foam had much lower density, but it had greater modulus (rigidity) and compressive strength than the fiber foam of the invention. Still, the R value for formulation 1 was surprisingly similar to that of the commercial comparative polystyrene sample.

TABLE 2
Comparison to Styrofoam

| | Density | Modulus | 10% Stress | R | |
|---|---|---|---|---|---|
| Sample | (g/cm³) | (MPa) | (MPa) | Value | Porosity |
| F1 | 0.0365 | 0.211 | 0.0208 | 3.7 | 0.9753 |
| F2 | 0.0573 | 0.499 | 0.0336 | 3.10 | 0.9675 |
| F3 | 0.0357 | 0.119 | 0.0138 | 3.32 | 0.9763 |
| Styrofoam | 0.0153 | 1.769 | 0.0949 | 3.8 | N/A |

### Example 3

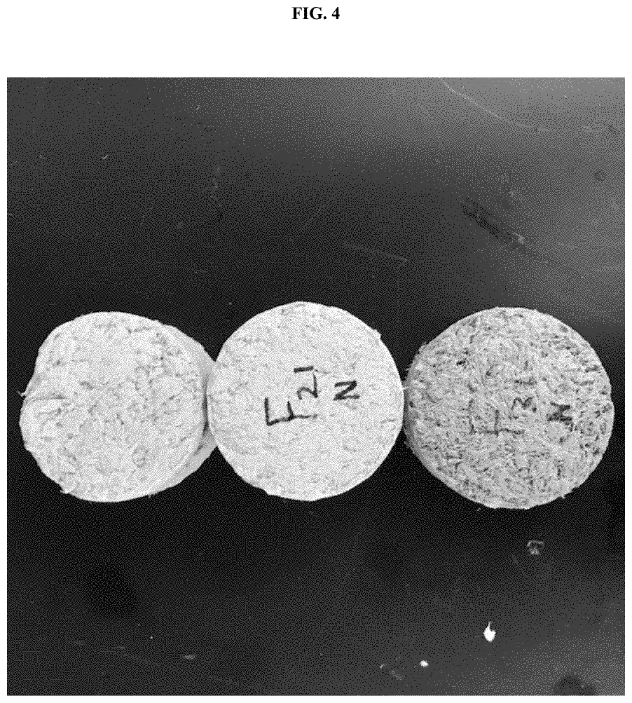

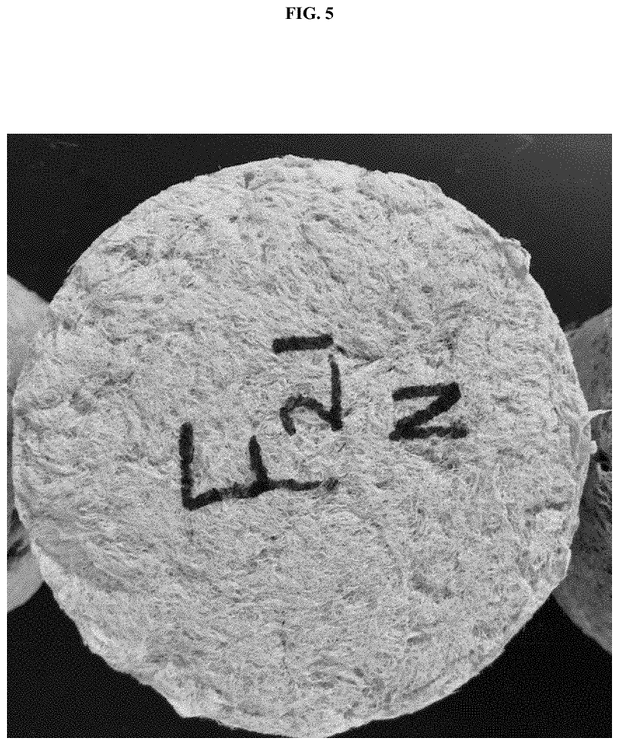

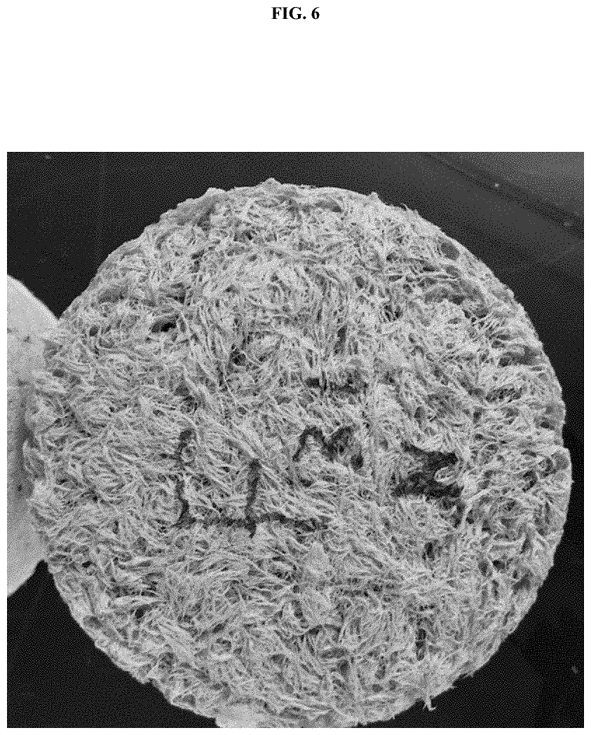

This example illustrates the physical appearance and insulative properties of the inventive composition. Dry foam samples had a distinctive appearance based on differences in formation. FIG. 4 photographically illustrates textural differences between foam samples made from formulations F1, F2, and F3 (from left to right). The two foam samples containing PLA fibers had a lighter appearance than the foam without PLA fibers. Formulation F2 was the lightest in color and was the densest due to the addition of a mineral filler (CaCO₃) in this example). CaCO₃ is a common mineral filler for plastics and is white in color. Close-up views of F2 revealed a very fine fiber structure (FIG. 5). From a distance, the sample looked nearly solid, but the close-up view showed the fine network of individual fibers. The structure of foams made from F1 was similar to that of the F2 sample shown in FIG. 5. In contrast to the formations containing PLA fibers, the dry foam made from formulation 3 (F3) had a much more porous fiber structure. Close-up views of the dry foam revealed a very course fiber network (FIG. 6). It was surprising that the blending of PLA fibers into the inventive composition helped to maintain separation between the cellulose fibers. As a result, the inventive foam was surprisingly a more effective insulator and had higher R values than was expected without the presence of the PLA (compare F1 and F3 above, where F1 has R value similar to commercial polystyrene with the addition of PLA to the inventive composition).

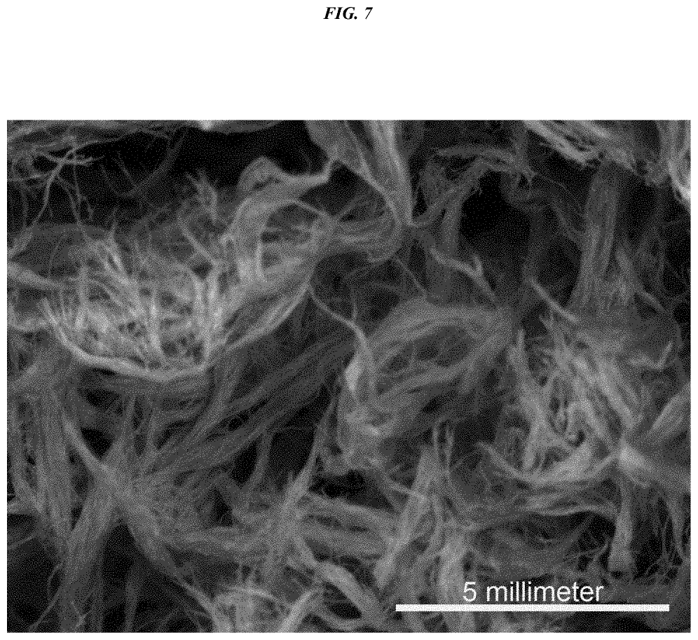

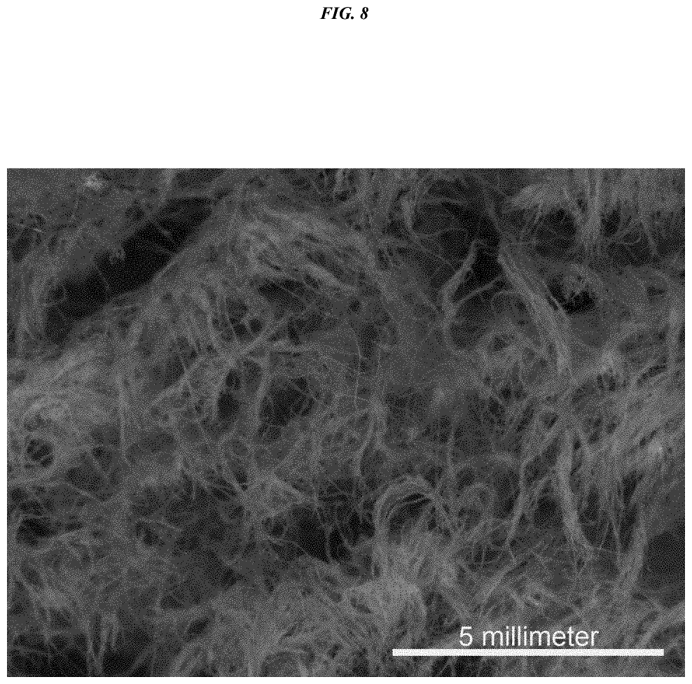

Microscopic examination of the inventive samples was performed using transmitted light in a LeicaMZ16F microscope (Leica Biosystems, Inc., Buffalo Grove, Ill.) equipped with a digital camera Retiga 2000R FAST color camera (Qimaging, Surrey, BC, Canada). Foam samples containing cellulosic and PLA fibers were cut to 2 mm slices and mounted on a standard microscope glass slide. Light exposure was adjusted to 300 milli-seconds. Settings at the zoom magnification changer were at positions 1 and 4. Scale bars were added after using ruler scans taken at the same setting. Microscopic views of F3 revealed that the course fiber structure seen in FIG. 6 was from bundles of several fibers that had become associated during the foaming process or during the drying step (FIG. 7). Not to bound by theory, it is likely the fibers formed into bundles due to hydrogen bonding with adjacent fibers. The formation of fiber bundles could happen during the foaming step or during the drying process while the fibers were still somewhat mobile within the overall structure. FIG. 8 is a photomicrograph demonstrating foam samples (F1 and F2) containing PLA fiber were surprisingly and unexpectedly much less porous. The void spaces between fibers were much smaller and the fiber network in general appeared to consist of fewer fiber bundles compared to samples containing no PLA fibers (i.e., F3). The PLA fibers (thin and long fibers apparent in FIG. 8) appeared to intercalate or intersperse between fibers of the unbleached kraft pulp thereby preventing them from associating with each other and forming the bundles that were so apparent in the F3 sample. This surprising and unexpected result could help increase the surface area of the foam containing PLA fibers and decrease the pore sizes of the foam.

By adding a fraction of PLA fiber to the cellulose fiber, the cellulose fiber was surprisingly prevented from aggregating into thick strands or yarns. One skilled in the art would have expected the cellulose fibers to associate more with other cellulose fibers and the PLA fibers to associate with other PLA fibers rather than the observed result. Not intending to be bound by theory, it is thought that the PLA fibers kept the cellulose fibers separated which resulted in a foam that had smaller pore sizes and improved the insulative properties (see R values in Table 2). Decreasing the pore size without increasing density is also thought to improve both thermal and acoustical insulation.

### Example 4

This example illustrates a process for forming the inventive composition into a plate as a potential commercial embodiment. Bleached softwood and hardwood pulp fiber samples were acquired from Georgia-Pacific (Atlanta, Ga.). Twenty grams of softwood and 10 grams of hardwood pulp fiber were torn into strips less than two inches wide and placed in a waring blender with 1 liter of hot (80° C.) water. After soaking for 10 min, the fiber was blended for 2 min to disperse evenly in the water. The contents of the blender were poured onto an 80-mesh screen and rinsed with water. The fiber was gathered by hand and squeezed to a final weight of 150 g consisting of approximately 30 g of total fiber and 120 g of water. One hundred g of PVA solution (5%) were added to the mixing bowl of a Hobart mixer. After adding the fiber, the contents were mixed for about two min when pre-gelatinized potato starch (about 12 g) was carefully added to the fiber mixture during this mixing step. The starch was slowly sprinkled into the mix to avoid lump formation. The mixture was stirred on the second speed (approximately 120 rpm) setting for 10 min. Next, 40 g of CaCO₃ was mixed into the mixture until thoroughly dispersed (approximately 5 min). Once the mixture was homogenously mixed and the fiber well-dispersed, 4 g of Foamcell 100 surfactant was added and mixed at the second speed setting for approximately 15 min. Once the surfactant was dispersed within the fiber mixture, a foam began to form. With additional mixing the foam increased in volume from about 600% to about 900% to the point of filling the mixing bowl.

A 30 cm′ aluminum plate was covered with a sheet of PLA film that was held in place by taping each corner. The wet foam was scooped out of the Hobart mixing bowl and evenly spread onto the PLA film to a thickness of 2 cm. The foam was placed into an oven held at 80° C. until it was thoroughly dry (i.e., dry until no further drop in weight occurred after 20 minutes of additional time in the oven—typically about 3 hours but total time is dependent on sample thickness). The PLA film served two purposes. First, to keep the foam from sticking to the aluminum plate and second, to provide a moisture barrier to the finished product. PLA is a biodegradable polymer that is desirable as a moisture barrier; however, PLA film does not generally adhere well to a starch/fiber substrate. Surprisingly, by drying the foam on a PLA film, it was possible to form a strong bond achieved by drying while disposed on the PLA film that was difficult to attain any other way. The PLA kept the wet foam mixture from adhering to the aluminum plate to which it was taped. Once dried, the PLA film adhered well to the foam and at the same time, made it very simple to remove the foam from the aluminum plate. Once removed from the aluminum plate, the foam was flipped over so that the film was facing upward. The foam was then placed in a plate mold and compressed at 160° C. for 10 s. The mold was opened, and the compression molded plate was removed to reveal a molded plate made from the starch/fiber composite material of the invention with an additional PLA film moisture/grease barrier. The temperature of the mold was such that the PLA did not melt. The PLA film will melt (typically PLA has a melting temperature of about 180° C.) and stick to the mold if the mold temperature is too high. Since the moisture content of the mold is low, it is not expected that the starch would have sufficient moisture to deform. Surprisingly, the dry foam was easily formed into a finished product that was attractive and covered with a PLA moisture barrier. One skilled in the art would generally expect the foam to crush and the starch would likely flake-off like a powder. However, it was surprisingly observed that under sufficient compressive force, the starch/fiber component compressed to form an attractive surface that had good strength. This finished product required surprisingly minimal processing (e.g., trimming of excess material around the edges) before the product would be ready for sale.

Table 3 shows a comparison of mechanical testing of plates formed using the inventive composition as compared to a commercially available product.

TABLE 3
Flexural properties of molded fiber plate
in comparison with that of invention

| | | Data at yielding point | | |
|---|---|---|---|---|
| | Modulus | Strain | Stress | Toughness |
| | (MPa) | (%) | (MPa) | (kPa) |
| Commercial | 5,570 ± 1420 | 1.70 ± 0.20 | 23.5 ± 6.2 | 277 ± 107 |
| molded pulp | | | | |
| fiber plate | | | | |
| Prototype plate | 7,070 ± 1,340 | 1.80 ± 0.40 | 59.2 ± 4.6 | 779 ± 211 |
| from current | | | | |
| invention | | | | |

### Example 5

This example illustrates the structural integrity and thermal insulative characteristics of the invention compositions. A wet foam of formulation F1 as described previously was prepared. A spatula was used to scoop the wet foam into the back-side cavity of a wine bottle shipper. Once the cavity was completely full, the back-filled shipper was placed in an oven to dry overnight at 80° C. Once the foam was dry, the shipper was reassembled and tested to determine whether it was functional as a wine bottle shipper. The critical criteria were maintaining the structural integrity, which was determined by a practical field test involving whether the foam-filled container maintained its shape and adequately protected a wine bottle from damage. The result confirmed that the inventive foam was surprisingly able to adequately insulate the package contents as well as providing protection. The foam was surprisingly successful at insulating the wine bottle (see R values in Table 2) so that the temperature of the wine bottle remained under a critical temperature during shipping to avoid the development of undesirable flavors in the wine.

### Example 6

This example illustrates using native starch as a filler for the inventive composition. A new formulation was made that provided a fiber sample with very small pore size and very good fiber dispersion. The sample was prepared by adding 20 g of unbleached pulp fiber (Olympic-16) and 5 g of PLA fibers to an industrial blender. Water (1 L) was brought to boiling and poured into the blender. The fiber was blended on low for 2 min and thereafter allowed to hydrate for 10 min. The inside surfaces of the blender were washed down with approximately 100 g water and the contents were blended again on low for 1 min. The contents were poured onto an 80-mesh screen and the blender was thoroughly rinsed of any remaining fiber. The fiber was then gathered by hand and squeezed to remove excess water. The final weight of the fiber blend was 75 g of which, 50 g was water and 25 g was fiber. The fiber blend was placed in a mixing bowl (Hobart, Model N50) and 50 g of 5% PVA and starch powder were added as indicated in Table 4 for the different samples. The fiber was mixed for 2 min to evenly distribute the PVA solution and starch granules. Foaming agent (2.5 g, CMX foaming agent, Richway Industries) was added to the mixture and mixed on speed #2. The foaming agent/PVA mixture effectively disbursed the fiber without the use of any starch as a viscosity modifier. Due to the extremely low moisture content, it was very surprising to see the mixture start to foam. The sample was mixed for approximately 10-15 min. until a small-cell foam was formed.

TABLE 4
Formulations for Low Moisture Foam Samples

| Sample | UB | PLA | | PVA | Native | Starch | Foaming | Density |
|---|---|---|---|---|---|---|---|---|
| (#) | Fiber (g) | Fiber (g) | Water (g) | (5%) (g) | Starch (g) | Type | Agent (g) | (g/cm³) |
| 1 | 20 | 5 | 50 | 50 | 0 | — | 2.5 | 0.029 |
| 2 | 20 | 5 | 50 | 50 | 25 | Waxy | 2.5 | 0.067 |
| 3 | 20 | 5 | 50 | 50 | 15 | Waxy | 2.5 | 0.068 |
| 4 | 20 | 5 | 50 | 50 | 25 | Dent | 2.5 | 0.048 |
| 5 | 20 | 5 | 50 | 50 | 12.5 | Potato | 2.5 | 0.030 |
| 6 | 20 | 5 | 65 | 50 | 25 | Potato | 2.5 | 0.045 |
| 7 | 20 | 2 | 50 | 50 | 50 | Potato | 2.5 | 0.063 |

The foam was placed on a tray covered with a sheet of polyester film (e.g., biaxially-oriented polyethylene terephthalate or Mylar®) and finally, two moist paper towels. Using a spacer of approximately 2.5 cm, the foam was formed into a sheet of uniform thickness and approximately 20 cm×15 cm. After smoothing the top surface, the foam was covered with dry paper towels and a paperboard sheet. The whole assembly was picked-up and inverted so that the dry paper towels and paperboard were on the bottom. The tray, Mylar® sheet and wet paper towels were removed to expose the foam surface that previously constituted the bottom surface. The new top surface was smoothed with a spatula. The spacers were removed, and the finished foam was carried on the paper towel/paperboard support and placed into an oven set at 80° C. The foam was dried for 30 min until a skin had formed on the foam surface. The foam was inverted, and the paper towels/paperboard which were soak with moisture were carefully removed from the foam. The bare foam was placed back into the oven to complete the drying step.

The addition of native starch surprisingly improved the density and compressive strength of the inventive foam composition.

### Example 7

This example illustrates additional embodiments for the inventive composition as shown in Table 5. After blending the fiber in 1 L water and letting it rest for about 10 min., the fiber was collected on a screen and the residual water was manually wrung out as much as possible. The resulting fiber ball was dry to the point that no additional water could be removed by hand. After adding 50 g PVA and SDS foaming agent, the mixture was mixed in a Hobart mixer for 3 min. The mixture made a good foam that dried well in the oven at about 80° C. in about 3 hours. The foam was cut into a square sample which was used to determine the bulk density. The foam had a good structure and a very fine pore size and low density. It didn't have great compressive strength but this formulation could represent the lightest, softest foams for cushioning. This formulation is quite inexpensive and could be used to infiltrate with molten wax or a PLA solution to improve moisture resistance or increase strength.

TABLE 5

| | Unbleached | PLA | Foaming | | PVA | |
|---|---|---|---|---|---|---|
| | Wood Fiber | Fiber | Agent- | Water | (5%) | Density |
| Sample | (g) | (g) | SDS (g) | (g) | (g) | (g/cm³) |
| Dry mix | 20 | 5 | 2.5 | 45 | 50 | 0.031 |
| Waxy | 25 | 0 | 2.5 | 75 | 50 | |
| Starch | | | | | | |
| (25 g/L) | | | | | | |

This sample was made solely of unbleached wood fiber. It was previously observed that starch helped to keep the fiber from forming into yarns. Not intending to be bound by theory, it was reasoned that the starch may be binding the fiber and helping it to stay dispersed. Accordingly, the unbleached fiber was first hydrated for 15 minutes in hot water and blended for 2 min, allowed to rest for 10 min, and blended a second time for 3 min (15 min pretreatment). Next, the fiber was washed with cold tap water on a screen. The fiber was squeezed of excess water and placed back into the blender with 1 L of cold tap water. The waxy corn starch (25 g) was added to the blender and the contents were all blended on high for 3 min. The fiber was collected on a sieve. Excess water was squeezed from the fiber ball. The final weight was 100 g. The fiber appeared to have been very well dispersed and it was somewhat surprising that no more water could be wrung from the fiber ball. The fiber and 50 g of PVA were mixed on medium speed for 1 min after which, 2.5 g of SDS were added while mixing at medium speed. The fiber seemed to disperse very well.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety, including any materials cited within such referenced materials. Furthermore, the invention encompasses any possible combination of some or all of the various embodiments and characteristics described herein and/or incorporated herein. In addition the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount.

All of the references cited herein, including U.S. Patents and U.S. Patent Application Publications, are incorporated by reference in their entirety.

Thus, in view of the above, there is described (in part) the following:

A composition comprising (or consisting essentially of) at least one fiber component, at least one foaming agent, at least one dispersant, and at optionally least one binder, wherein the fiber component forms a viscous mixture that is converted to a foam product upon the addition of the foaming agent once the viscous mixture reaches a predetermined dryness, wherein the foam product is resistant to shrinkage during drying and remains rigid.

A process for a making a foam composition, said process comprising (or consisting essentially of) mixing at least one fiber component in water to create a hydrated fiber; removing excess water and mixing said fiber with at least one dispersant and optionally at least one binder, and subsequently mixing in at least one foaming agent to create the foam composition.

The above process, comprising (or consisting essentially of) mixing at least one fiber component in water to create a hydrated fiber; removing excess water and mixing said fiber with at least one dispersant and at least one binder, and subsequently mixing in at least one foaming agent to create the foam composition.

An article of manufacture made from the above composition.

An article of manufacture made from the above composition, wherein said article is compression molded.

A composition comprising (or consisting essentially of) at least one fiber component, at least one foaming agent, at least one dispersant, and optionally at least one binder, wherein the fiber component forms a viscous mixture that is converted to a foam product upon the addition of the foaming agent once the viscous mixture reaches a predetermined dryness, wherein the foam product is resistant to shrinkage during drying and remains rigid; wherein said composition is produced by a process comprising (or consisting essentially of) mixing at least one fiber component in water to create a hydrated fiber; removing excess water and mixing said fiber with at least one dispersant and optionally at least one binder, and subsequently mixing in at least one foaming agent to create the foam composition.

The above composition according, wherein said composition comprises (or consists essentially of) at least one fiber component, at least one foaming agent, at least one dispersant, and at least one binder, wherein the fiber component forms a viscous mixture that is converted to a foam product upon the addition of the foaming agent once the viscous mixture reaches a predetermined dryness, wherein the foam product is resistant to shrinkage during drying and remains rigid; wherein said composition is produced by a process comprising (or consisting essentially of) mixing at least one fiber component in water to create a hydrated fiber; removing excess water and mixing said fiber with at least one dispersant and at least one binder, and subsequently mixing in at least one foaming agent to create the foam composition.

A foam composition comprising a fiber component, at least one foaming agent, at least one dispersant, and optionally at least one binder, wherein the components form a viscous mixture that is converted to a foam product by the mechanical mixing in of the foaming agent. This foam may be dried to form a solid, and both viscous and solid forms of the foam are claimed herein.

A process for a making the above foam composition, said process comprising mixing a fiber in water to create a hydrated fiber, removing excess water from the fiber and mixing said fiber with at least one dispersant to create a dispersed fiber and mixing said dispersed fiber with at least one binder to create a viscous fiber suspension, and mixing said viscous fiber suspension with at least one foaming agent to entrain air or other gas thereby creating the foam composition.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein).

The invention illustratively disclosed herein suitably may be practiced in the absence of any element (e.g., method (or process) steps or composition components) which is not specifically disclosed herein. Thus, the specification includes disclosure by silence (“Negative Limitations In Patent Claims,” AIPLA Quarterly Journal, Tom Brody, 41(1): 46-47 (2013): “ . . . Written support for a negative limitation may also be argued through the absence of the excluded element in the specification, known as disclosure by silence . . . Silence in the specification may be used to establish written description support for a negative limitation. As an example, in Ex parte Lin [No. 2009-0486, at 2, 6 (B.P.A.I. May 7, 2009)] the negative limitation was added by amendment . . . In other words, the inventor argued an example that passively complied with the requirements of the negative limitation . . . was sufficient to provide support . . . This case shows that written description support for a negative limitation can be found by one or more disclosures of an embodiment that obeys what is required by the negative limitation . . . .”

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims. Although any methods (or processes) and materials similar or equivalent to those described herein can be used in the practice or testing of the present invention, the preferred methods (or processes) and materials are herein described. Those skilled in the art may recognize other equivalents to the specific embodiments described herein which equivalents are intended to be encompassed by the claims attached hereto.

The claimed invention is:

1. A composition comprising a fiber component, at least one foaming agent, at least one dispersant, and at optionally least one binder, wherein the fiber component forms a viscous mixture that is converted to a foam product upon the addition of the foaming agent once the viscous mixture reaches a predetermined dryness, wherein the foam product is resistant to shrinkage during drying and remains rigid.

2. The composition of claim 1, wherein the fiber component is selected from the group consisting of at least one plant-derived complex carbohydrate, crop waste fibers, wood, lignocellulosic fibrous material, fiber crops, and combinations thereof.

3. The composition of claim 1, wherein the binder is distributed essentially throughout the fiber component to create a fiber matrix.

4. The composition of claim 1, wherein the binder is selected from the group consisting of polyvinyl alcohols, starches, gums, alginate, sodium silicate, and combinations thereof.

5. The composition of claim 1, wherein the binder is native starch.

6. The composition of claim 1, wherein the foaming agent is SDS.

7. The composition of claim 1, wherein the binder is polyvinyl alcohol and is present in an amount from 0.5 to about 10 in terms of wt % of the foam product.

8. The composition of claim 1, wherein said dispersant is selected from the group consisting of polyvinyl alcohol; pregelatinized starches; carboxymethyl cellulose and its derivatives; hydroxymethyl cellulose and its derivatives; water soluble viscosity modifiers; plant gums; and combinations thereof.

9. The composition of claim 1, wherein the viscous mixture has a predetermined viscosity.

10. The composition of claim 1, further comprising increased thermal insulative properties.

11. The composition of claim 1, further comprising increased acoustic insulative properties.

12. The composition of claim 1, wherein the foam product is rigid and stable.

13. The composition of claim 1, wherein the foam product is at least about 95% of its pre-dried size after drying.

14. The composition of claim 1, wherein said composition comprises at least one binder.

15. A process for a making a foam composition, said process comprising mixing a fiber component in water to create a hydrated fiber; removing excess water and mixing said fiber with at least one dispersant and optionally at least one binder, and subsequently mixing in at least one foaming agent to create the foam composition.

16. The process of claim 15, comprising mixing a fiber component in water to create a hydrated fiber; removing excess water and mixing said fiber with at least one dispersant and at least one binder, and subsequently mixing in at least one foaming agent to create the foam composition.

17. The process of claim 14, wherein the fiber is a fiber pulp.

18. The process of claim 14, wherein the binder is selected from the group consisting of a gelatinized slurry of starch and a pregelatinized starch powder.

19. An article of manufacture made from the composition of claim 1.

20. An article of manufacture made from the composition of claim 1, wherein said article is compression molded.

21. A composition comprising a fiber component, at least one foaming agent, at least one dispersant, and optionally at least one binder, wherein the fiber component forms a viscous mixture that is converted to a foam product upon the addition of the foaming agent once the viscous mixture reaches a predetermined dryness, wherein the foam product is resistant to shrinkage during drying and remains rigid; wherein said composition is produced by a process comprising mixing a fiber component in water to create a hydrated fiber; removing excess water and mixing said fiber with at least one dispersant and optionally at least one binder, and subsequently mixing in at least one foaming agent to create the foam composition.

22. The composition according to claim 21, wherein said composition comprises a fiber component, at least one foaming agent, at least one dispersant, and at least one binder, wherein the fiber component forms a viscous mixture that is converted to a foam product upon the addition of the foaming agent once the viscous mixture reaches a predetermined dryness, wherein the foam product is resistant to shrinkage during drying and remains rigid; wherein said composition is produced by a process comprising mixing a fiber component in water to create a hydrated fiber; removing excess water and mixing said fiber with at least one dispersant and at least one binder, and subsequently mixing in at least one foaming agent to create the foam composition.
